(19) United States
(12) Patent Application Publication
(10) Pub. No.: US 2008/0005175 A1
(43) Pub. Date: Jan. 3, 2008

(54) CONTENT DESCRIPTION SYSTEM

(76) Inventors: Adrian Bourke, San Diego, CA (US); Michael Floyd, San Diego, CA (US); Shaiwal Priyadarshi, San Diego, CA (US); Alexander van Zoest, San Diego, CA (US)

Correspondence Address: KAUTH , POMEROY , PECK & BAILEY ,LLP, P.O. BOX 19152, IRVINE, CA, 92623, US

(21) Appl. No.: 11/757,318

(22) Filed: Jun. 1, 2007

Related U.S. Application Data
(60) Provisional application No. 60/810,427, filed on Jun. 1, 2006.

(51) Int. Cl. G06F 17/00

(52) U.S. Cl. 707/104.1; 707/E17.009

(57) ABSTRACT

Content description systems in accordance with embodiments of the invention are described. In many embodiments, the content description system includes files that combine RIFF chunks with metadata. In several embodiments, the content description system includes metadata stored as graph information and separate node information. One embodiment includes a storage medium and metadata recorded in the storage medium. In addition, the metadata includes graph information and separate node data.

### CROSS-REFERENCE TO RELATED APPLICATION(S)

This application claims the benefit of U.S. Provisional Application Ser. No. 60/810,427, filed Jun. 1, 2006, the entire contents of which are incorporated herein by reference.

### BACKGROUND OF THE INVENTION

The present invention relates generally to a content description system. Such a system can be used in conjunction with the encoding, transmission and decoding of multimedia files as described in U.S. patent application Ser. No. 11/258,496, entitled “Multimedia Distribution System,” filed Oct. 24, 2005 and U.S. patent application Ser. No. 11/327,543, entitled “Distributing and Displaying Still Photos in a Multimedia Distribution System,” filed Jan. 5, 2006. The disclosure of both applications is incorporated herein by reference in its entirety.

### SUMMARY OF THE INVENTION

Content description systems in accordance with embodiments of the invention are described that enable the description of files, objects, entities and/or anything capable of description using graphs that reference separate node. In many embodiments, files are created that include a RIFF chunk containing multimedia information and separate metadata chunks.

One embodiment of the invention includes a storage medium and metadata recorded in the storage medium. In addition, the metadata includes graph information and separate node data.

In a further embodiment of the invention, the graph information includes a sequence of packets containing metadata triples and the metadata triples include data representing a subject, a predicate and an object.

In another embodiment of the invention, the graph information includes a header, the header includes information indicative of the number of packets in the sequence of packets, and the header includes information concerning the number of metadata triples in the sequence of packets.

In a still further embodiment of the invention, each metadata triple includes data representing a version.

In still another embodiment of the invention, a version is associated with each piece of data representing a subject, a predicate or an object.

In a yet further embodiment of the invention, the node data includes a sequence of packets and each packet contains reference data or a data value.

In yet another embodiment of the invention, the node data includes a header, the header includes information indicative of the number of packets containing reference data, and the header includes information indicative of the number of packets containing data values.

In a further embodiment again, the subject in a metadata triple includes a reference to a packet containing node data, and the referenced packet contains reference data.

In another embodiment again, the predicate in a metadata triple includes a reference to a standard vocabulary.

In a further additional embodiment, the object in a metadata triple includes a reference to a packet containing node data, and the referenced packet contains a data value.

In another additional embodiment, the object in a metadata triple includes a reference to a packet containing node data, and the referenced packet contains reference data.

In a still yet further embodiment, the subject or the object in a metadata triple includes a reference to a blank node.

In still yet another embodiment, the storage medium is an optical storage medium.

In a still further embodiment again, the storage medium is a magnetic storage medium.

In still another embodiment again, the storage medium is a random access memory.

In a still further additional embodiment, the storage medium is a read only memory.

In still another additional embodiment, the data is a file including a metadata chunk.

In a still yet further embodiment again, the file includes multimedia stored in a RIFF chunk.

In still yet another embodiment again, the data is a database.

A still yet further additional embodiment includes a storage device containing a file. In addition, the file includes multimedia stored in a RIFF chunk and a metadata chunk.

In still yet another additional embodiment, the metadata chunk includes a chunk containing graph information and a chunk containing node data.

A still further additional embodiment again includes a processing device, a storage device, a graph memory, and a node data memory. In addition, metadata is stored on the storage device, the metadata includes graph information and node data, the processor is configured to load the graph information into the graph memory, and the processor is configured to construct a graph using the graph information.

In still another additional embodiment again, the graph information includes metadata triples that include data representing a subject, a predicate and an object, and the subject, the predicate and the object each reference node data.

In a yet further embodiment again, the processor is configured to search the graph to locate a metadata triple, and the processor is configured to locate at least one piece of node data referenced by the metadata triple.

In yet another embodiment again, the processor is configured to load the referenced node data into the node data memory.

In a yet further additional embodiment, the metadata decoding system is assigned a version, the metadata triple is assigned a version, and the processor is configured to only store metadata triples in the graph memory that have a version that is the same as or earlier than the version of the metadata decoding system.

In yet another additional embodiment, the metadata triple uses a standardized vocabulary.

In a yet further additional embodiment again, the metadata decoding system is assigned a version, a standardized vocabulary version is assigned to each piece of data representing a subject, a predicate or an object, and the processor is configured to only decode node data referenced by the meta data triples with a standardized vocabulary version that is the same as or earlier than the version of the metadata decoding system.

A further additional embodiment again, includes a computing device, and at least one storage device containing a plurality of sets of metadata. In addition, at least one of the storage devices includes at least one inference rule, each set of metadata includes graph information and separate node data, and the computing device is configured to generate a recommendation using the inference rules to search the sets of metadata.

In another additional embodiment again, the processor is configured to construct graphs using the sets of metadata in the and to search the graphs using the at least one inference rule to make recommendations.

In another further embodiment, the computing device is configured to construct a first graph using a first set of metadata, the computing device is configured to locate a first piece of metadata specified by an inference rule within the first graph, the computing device is configured to construct a second graph using a second set of metadata, the computing device is configured to locate a second piece of metadata specified by the inference rule within the second graph, the computing device is configured to locate a third piece of metadata in the second graph in response to the location of the second piece of metadata, where the nature of the third piece of metadata is specified by the inference rule, and the computing device is configured to return the third piece of metadata as a recommendation.

Still another further embodiment, includes a computing device, and at least one storage device containing metadata. In addition, the metadata includes graph information and node data, at least one of the storage devices includes at least one advertising rule, and the computing device is configured to select advertising based on a search of the metadata using the advertising rules.

In yet another further embodiment, the processor is configured to construct a graph using the metadata and to search the graph using the at least one advertising rule to identify an appropriate advertisement.

In another further embodiment again, the computing device is configured to construct a graph using the metadata, the computing device is configured to locate a piece of metadata specified by an advertising rule within the graph, and the computing device is configured to identify an appropriate advertisement in response to the location of the piece of metadata.

Another further additional embodiment includes a computing device connected to a network, a server connected to the network and a storage device accessible by the computing device, where the storage device contains metadata. In addition, the metadata includes graph information and separate node data.

In still yet another further embodiment, the computing device includes metadata describing the computing device. In addition, the metadata describing the computing device includes graph information and separate node data.

In still another further embodiment again, the server includes metadata describing the server. In addition, the metadata describing the server includes graph information and separate node data.

In still another further additional embodiment, the metadata contained on the storage device describes a file, the server stores metadata relevant to the file, the computing device is configured to obtain the metadata relevant to the file from the server, and the computing device is configured to update the metadata contained on the storage device to reflect the metadata obtained from the server.

In yet another further embodiment again, the metadata contained on the storage device is part of the file described by the metadata.

In yet another further additional embodiment, the metadata stored on the server includes a version, and the metadata contained on the storage device includes a version. In additional, the computing device is configured to update the metadata contained on the storage device when the metadata stored on the server includes a more recent version than the metadata contained on the storage device.

In another further additional embodiment again, the metadata stored on the server includes an authority identifier, and the computing device is configured to update the metadata contained on the storage device depending upon the authority identifier of the metadata stored on the server.

An embodiment of the method of the invention includes expressing descriptive information in triples including a subject, a predicate and an object, and representing the triples as a graph and a series of nodes referenced by the graph.

A further embodiment of the method of the invention includes recording the graph and the nodes in a file as separate chunks within a metadata chunk.

Another embodiment of the method of the invention includes forming a graph chunk as a sequence of packets where each packet includes a subject, a predicate and an object.

A further embodiment again of the method of the invention includes forming the sequence of packets so that a node referenced by a subject in a packet in the sequence is not referenced by the object in a subsequent packet in the sequence.

Another embodiment again of the method of the invention includes expressing the descriptive information as triples that include a version, and updating the triples using triples having a more recent version.

A still further embodiment of the method of the invention includes, locating additional descriptive information expressed as triples associated with an authority, and determining whether to update the expressed descriptive information with the additional descriptive information based upon the authority.

Still another embodiment of the method of the invention includes determining the preferred triple in a set of triples with the same subject, predicate, and object.

### BRIEF DESCRIPTION OF THE DRAWINGS

FIG. 1 is a diagram of a system for encoding, distributing and decoding files incorporating a content description system in accordance with an embodiment of the present invention.

FIG. 2 is a diagram of the structure of a multimedia file in accordance with an embodiment of the present invention.

FIG. 3 is a conceptual diagram of a metadata triple in accordance with an embodiment of the present invention.

FIG. 4 is a conceptual diagram of a metadata triple with cardinality in accordance with an embodiment of the invention.

FIG. 5 is a conceptual diagram of a metadata triple localized in multiple languages in accordance with an embodiment of the invention.

FIG. 6 is a conceptual diagram of a triple with a URI Reference in accordance with an embodiment of the invention.

FIG. 7 is a diagram of the structure of a RIFF metadata system in accordance with an embodiment of the present invention.

FIG. 8a is a diagram of the structure of a graph bitstream chunk in accordance with an embodiment of the present invention.

FIG. 8b is a diagram of the structure of a graph bitstream chunk with a breakout of the header section in accordance with an embodiment of the present invention.

FIG. 8c is a table describing components of the header section of the graph bitstream chunk in accordance with an embodiment of the present invention.

FIG. 8d is a diagram of the structure of a graph bitstream chunk with a breakout of a packet section in accordance with an embodiment of the present invention.

FIG. 8e is a table describing components of a packet section of the graph bitstream chunk in accordance with an embodiment of the present invention.

FIG. 8f is a diagram of the structure of a graph bitstream chunk with a breakout of the version portion of a packet section in accordance with an embodiment of the present invention.

FIG. 9a is a diagram of the structure of a node data bitstream chunk in accordance with an embodiment of the present invention.

FIG. 9b is a diagram of the structure of a node data bitstream chunk with a breakout of the header section in accordance with an embodiment of the present invention.

FIG. 9c is a table describing components of the header section of the note data bitstream chunk in accordance with an embodiment of the present invention.

FIG. 9d is a diagram of the structure of a node data bitstream chunk with a breakout of a packet section in accordance with an embodiment of the present invention.

FIG. 9e is a table describing components of a packet section of the node data bitstream chunk in accordance with an embodiment of the present invention.

FIG. 10a is a conceptual diagram of a graph of multiple metadata triples in accordance with an embodiment of the invention.

FIG. 10b is a schematic diagram of graph and node data bitstream chunks containing the metadata triples of FIG. 10a in accordance with an embodiment of the invention.

FIG. 11a is a schematic diagram of graph and node data bitstream chunks containing multiple triple versions in accordance with an embodiment of the invention.

FIG. 11b is a conceptual diagram of a graph in accordance with an embodiment of the present invention conceptually illustrating the graph and node data bitstream chunks of FIG. 11a.

FIG. 12a is a diagram of graph and node data bitstreams chunks containing metadata that utilizes different vocabulary versions in accordance with an embodiment of the invention.

FIG. 12b is a conceptual diagram of a graph in accordance with an embodiment of the present invention conceptually illustrating the graph and node data bitstream chunks of FIG. 12a.

FIG. 13 is a block diagram of a metadata decoder system in accordance with an embodiment of the invention.

FIG. 14 is a flowchart of the operation of the metadata decoder system of FIG. 13 in accordance with an embodiment of the invention.

FIG. 15 shows a flowchart of the operation of the metadata decoder system of FIG. 13 with regard to versioning in accordance with an embodiment of the invention.

FIGS. 16a to 16h are a table showing a metadata vocabulary for multiple languages in accordance with an embodiment of the invention.

FIGS. 17a to 17e are a table showing a metadata vocabulary for countries in accordance with an embodiment of the invention.

### DETAILED DESCRIPTION OF THE INVENTION

Referring to the drawings, embodiments of content description systems are described. In one embodiment, the content description system includes a number of electronic devices in communication with each other that can be used to create, store, review, exchange and modify descriptive information. The descriptive information can include the type of device that is part of the content description system, the preferences of the users who are making use of the system, the types of files stored on a device, the content of files, or any other information. The descriptive information that can be created, stored, reviewed, exchanged and modified using a content distribution system in accordance with an embodiment of the present invention is virtually unlimited.

In one embodiment, at least of some of the descriptive information within the content distribution system is represented as metadata. Metadata is a term used to describe data that provides descriptive information about the contents of a file, a component of the system, a user or any other person, device or entity capable of description. In many embodiments, metadata is stored within a multimedia file and the metadata includes information that describes aspects of the file. For example, the metadata can store content specific information such as title, author, copyright holder and cast. In addition, the metadata can store technical information about the file such as the details of the codec used to encode the contents of the file. Furthermore, the metadata can include user specific information such as reviews of the content within the file. In addition, metadata in accordance with embodiments of the present invention can be stored separate from the file or entity that the metadata describes. In this way, a metadata repository can be created that can be referenced by all users or a selected group of users within the system.

In many embodiments, metadata is capable of representing relationships between various pieces of information where both the information and the relationships between the information can be represented using a graph. When metadata is represented as a graph, the nodes of the graphs typically have information associated with them and the relationships are represented as paths between the nodes. In a number of embodiments, metadata is represented using a first structure containing information from which a graph can be constructed and a separate second structure that contains information associated with the nodes of the graph. In several embodiments, information associated with a graph is stored in a number of separate locations. For example, a graph node can reference the information stored in the second structure or information located in another file either locally or on another device. Separating the graph information from the node information in this manner can increase the efficiency with which a device can access metadata. A device can load the graph information (typically smaller than the information associated with the nodes), locate the node referencing the desired information and then use the node information to index into the second structure to locate the desired information.

As discussed above, content description systems in accordance with embodiments of the present invention possess the ability to access and manipulate metadata. The ability to access and manipulate metadata can enable the performance of high level functions such as searching or drawing inferences. High level functions such as inferencing can be used to provide users with recommendations based upon metadata about them, metadata about files or devices within the system that the user enjoys accessing or accesses frequently and metadata collected in relation to others users or user groups.

In several embodiments, metadata is represented using a standard vocabulary. A standard vocabulary typically provides predictability with respect to the manner in which descriptive information is expressed. This predictability can simplify the performance of high level functions such as searching metadata and using metadata to form conclusions, draw inferences and make recommendations to users. Use of a standard vocabulary can also enable the metadata to be platform independent.

In a number of embodiments, a standard vocabulary is used that contains vocabulary terms that can be expressed in any of a number of different languages. Irrespective of the language in which the vocabulary term is expressed, the content description system can recognize that the vocabulary term is equivalent to the same term expressed in a different language. This allows the creation of information in a first language that can be viewed by a user in another language, in a way that is transparent to the user. The use of vocabulary terms that can be expressed in multiple languages also enables high level functions, such as searching, to be performed that are not restricted to drawing upon information from only one language in performing the function.

Content description systems in accordance with embodiments of the present invention can also support multiple standard vocabularies. As part of the standardization process, new terms can be added to the vocabulary and the inclusion of the new terms can create a new version of the standardized metadata vocabulary. The metadata vocabulary can change frequently or infrequently. New relationships may be formed or new words or countries may be added to the vocabulary. In this way, more than one version of metadata vocabulary can be in use. In many embodiments, devices are capable of processing metadata expressed using one or more versions of the metadata vocabulary. In addition, devices can ignore metadata expressed using a version of the metadata vocabulary for which the device is not configured.

### Content Description Systems

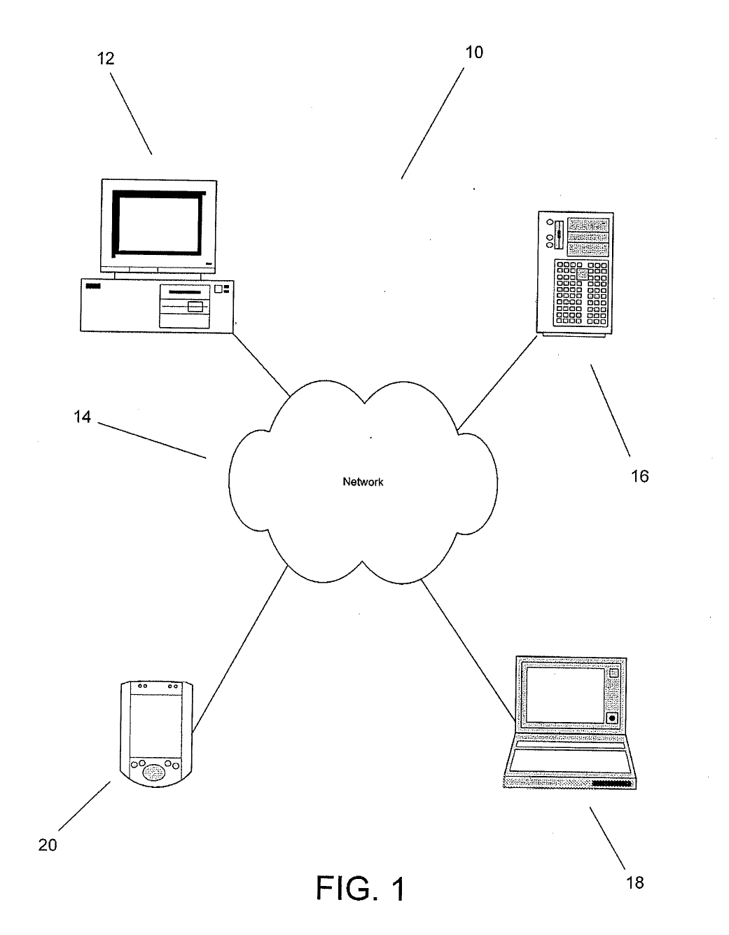

A content description system that can be used for encoding, distributing, searching and decoding files containing metadata in accordance with an embodiment of the invention is shown in FIG. 1. The content description system 10 includes a computer 12, which is connected to a variety of other computing devices via a network 14. Devices that can be connected to the network include a server 16, a lap-top computer 18 and a personal digital assistant (PDA) 20. In various embodiments, the connections between the devices and the network can be either wired or wireless and implemented using any of a variety of networking protocols.

In operation, the computer 12 can be used to encode files containing metadata in accordance with an embodiment of the present invention. The computer 12 can also be used to decode files containing metadata in accordance with embodiments of the present invention and distribute files containing metadata in accordance with embodiments of the present invention. The computer can distribute files using any of a variety of file transfer protocols including via a peer-to-peer network. In addition, the computer 12 can transfer files in accordance with embodiments of the present invention to a server 16, where the files can be accessed by other devices. The other devices can include any variety of computing devices or even a dedicated decoder device. In the illustrated embodiment, a lap-top computer and a PDA are shown. In other embodiments, digital set-top boxes, desk-top computers, game machines, consumer electronics devices and other devices can be connected to the network, which can download files containing metadata and decode them. In one embodiment, the files used in the system can be multimedia files. In many embodiments, the files contain metadata.

In one embodiment, the devices access the metadata on the server via the network. In other embodiments, the devices access the metadata from a number of computers via a peer-to-peer network. In several embodiments, metadata can be written to a portable storage device such as a disk drive, CD-ROM, DVD, or other device. In many embodiments, electronic devices can access metadata written to portable storage devices.

In a number of embodiments, the content description system provides the capability to search the metadata within a file. Searches can be based on the title, actors, directors, or other stored information relating to a video, photo, or audio work in the multimedia file. In one embodiment, the metadata may itself be used to search another file, the internet, or a network.

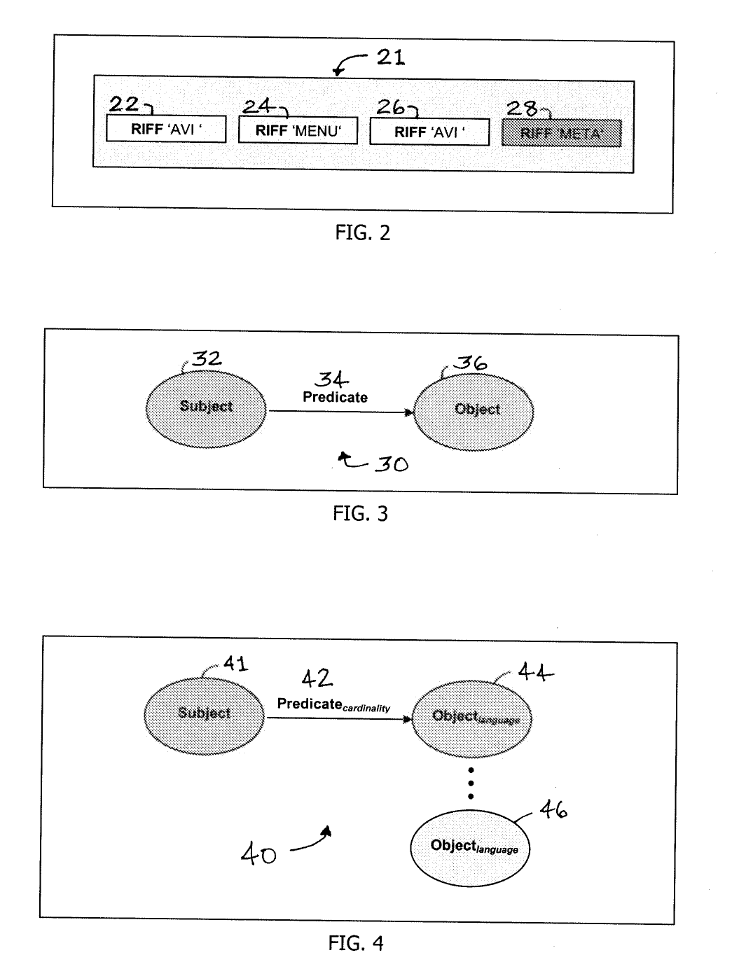

A multimedia file that includes metadata in accordance with an embodiment of the invention is shown in FIG. 2. The multimedia file includes at least one multimedia presentation, menu information, and metadata.

Multimedia files in accordance with embodiments of the present invention can be structured to be compliant with the Resource Interchange File Format (‘RIFF file format’), defined by Microsoft Corporation of Redmond, WA and International Business Machines Corporation of Armonk, N.Y. RIFF is a file format for storing multimedia data and associated information. A RIFF file typically has a header, which identifies the file and provides the residual length of the file after the header. The entire remainder of the RIFF file comprises “chunks” and “lists.”

An AVI file is a special form of RIFF file that follows the format of a RIFF file, but include various chunks and lists with defined identifiers that contain multimedia data in particular formats. The AVI format was developed and defined by Microsoft Corporation. AVI files are typically created using an encoder that can output multimedia data in the AVI format. AVI files are typically decoded by any of a group of software collectively known as AVI decoders.

In the illustrated embodiment, the multimedia file can include multiple RIFF chunks. In one embodiment, the multimedia file 21 can contain a RIFF AVI chunk 22, a RIFF MENU chunk 24, a second RIFF AVI chunk 26, and a RIFF META chunk 28. The RIFF MENU chunk can be used to generate a menu interface to access the contents of the file and metadata concerning the contents of the file. The RIFF AVI chunk can contain various multimedia data including audio, video, photo, or other multimedia data. The RIFF META chunk can contain metadata about the contents of RIFFs within the multimedia file or other files external to the multimedia file. In another embodiment, metadata is provided by servers rather than in a multimedia file.

### Metadata

Metadata in accordance with embodiments of the present invention can be expressed as a series of statements (or triples) including a subject, a predicate and an object. FIG. 3 shows a triple in accordance with an embodiment of the present invention. The triple 30 includes a subject 32, a predicate 34 and an object 36.

The subject is a reference to what is being described and can reference anything having characteristics capable of description such as a file, item, person or organization. In one embodiment, the subject can be expressed as a URI reference (see discussion below) or a blank node. The predicate identifies a characteristic of the subject that is being described. In one embodiment, the predicate is a URI Reference drawn from a specified vocabulary. The object is the value of the property being described by the subject and the predicate relationship. In one embodiment, the object may be a URI Reference, blank node, or value.

A URI Reference (Uniform Resource Identifier) is a string of characters used for uniquely identifying resources. Unlike a URL, or Uniform Resource Locator used to locate things on the internet, a URI Reference is not limited to identifying resources that have a network resolvable location. For example, the URI Reference “urn:isbn:0-19-286212-X” identifies the book “The Meme Machine” by Susan Blackmore. It does not specify the location of the book or where to reference to find additional information about the book. The URL “http://www.oup.co.uk/isbn/0-19-286212-X” specifies the location of a website provided by the publishers of “The Meme Machine,” and rather than identifying the book, it provides location to find a description and summary of the book. It does not specifically identify the book, and therefore information associated with the URL may be in association with more than just the book. Use of a URL (or other type of locater) can lead to ambiguity, which reduces the fidelity of the information used to draw inferences with metadata.

In one embodiment, the relationship of the subject, predicate, and object can be expressed using a graph. A graph can be a collection of triples visually represented by a node and directed arc diagram, as in FIG. 3. Each triple can be represented as a node-arc-node link, where the subject and object are nodes and the predicate is the adjoining arc. The arc can establish the relationship between the nodes. The node at the end of the arc can represent the object, while the node at the beginning of the arc can represent the subject. As previously discussed, a URI Reference can be used for either the subject, the object or the predicate.

### Standardized Metadata Vocabularies

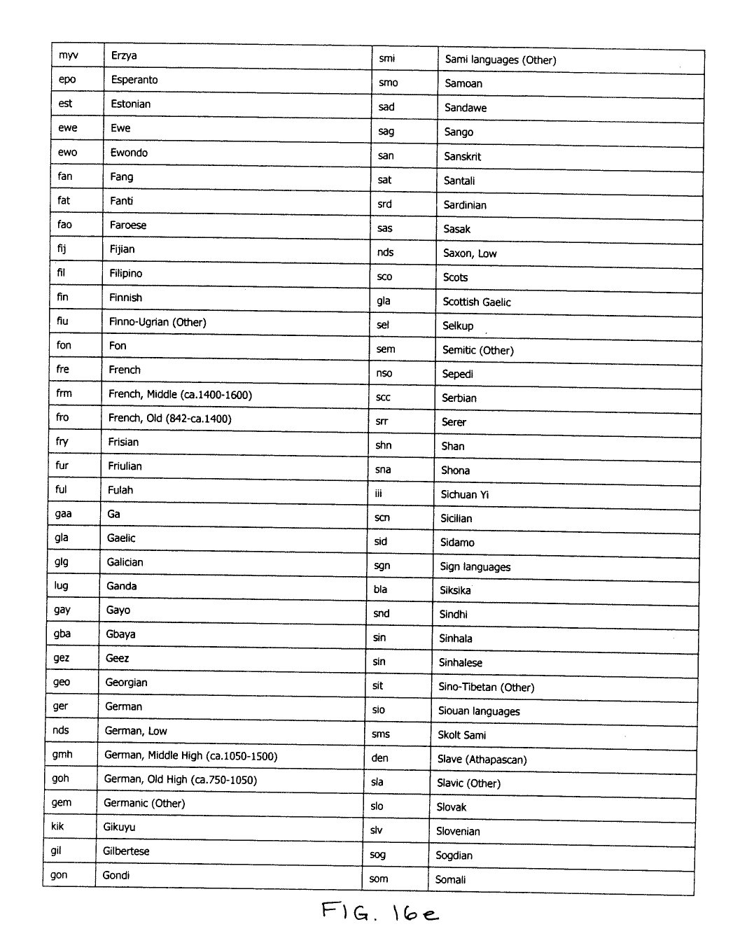

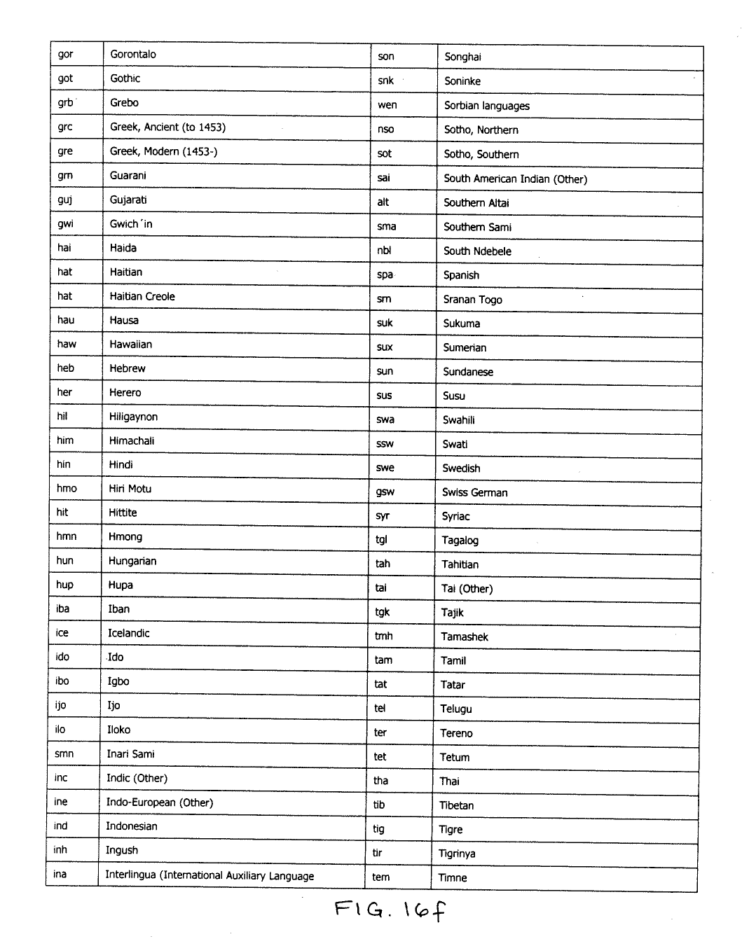

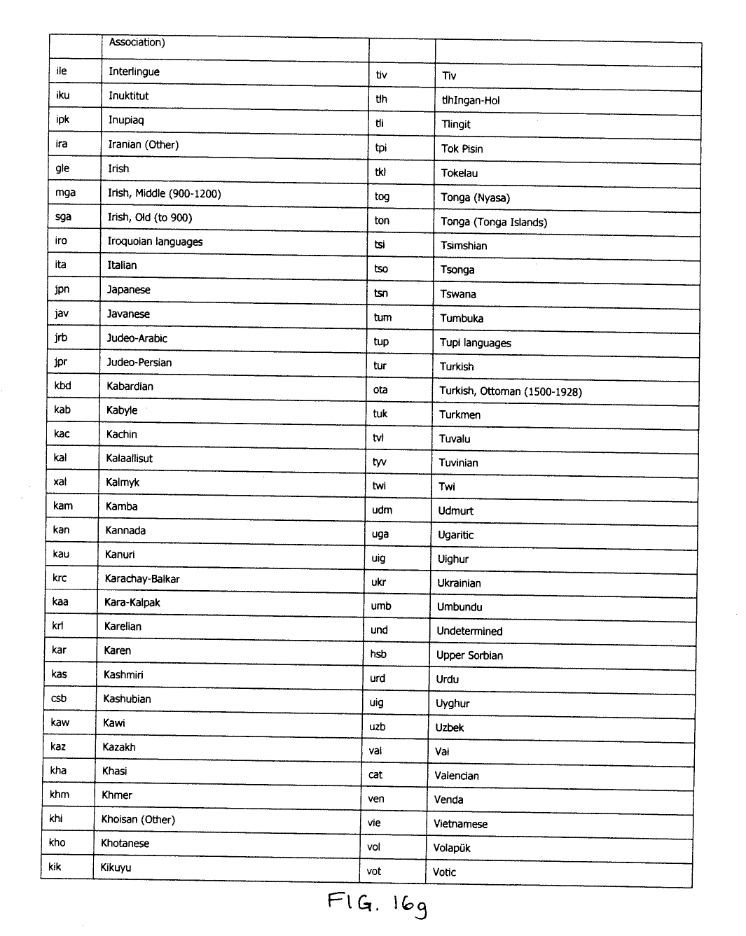

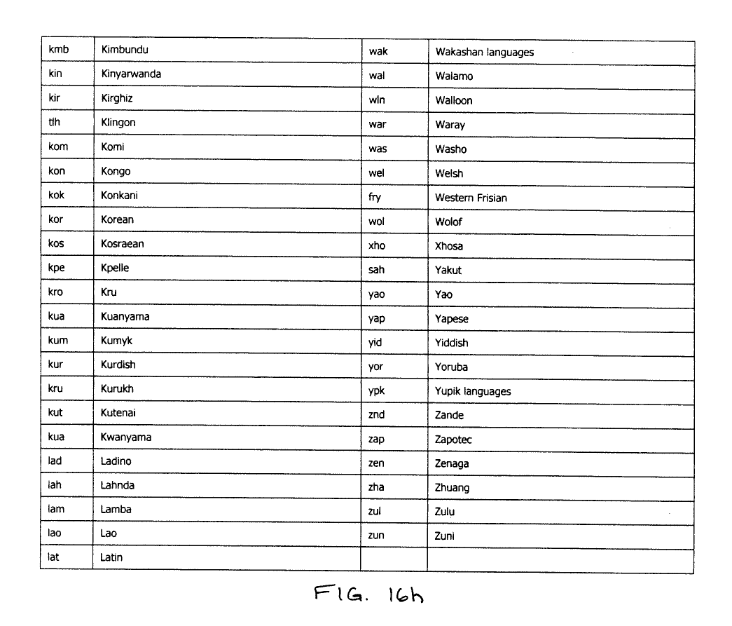

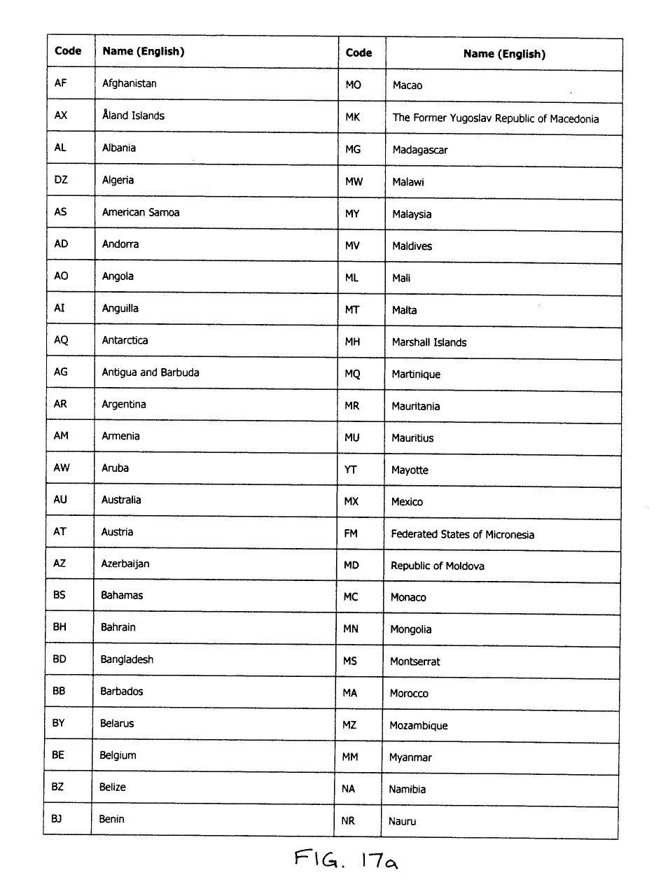

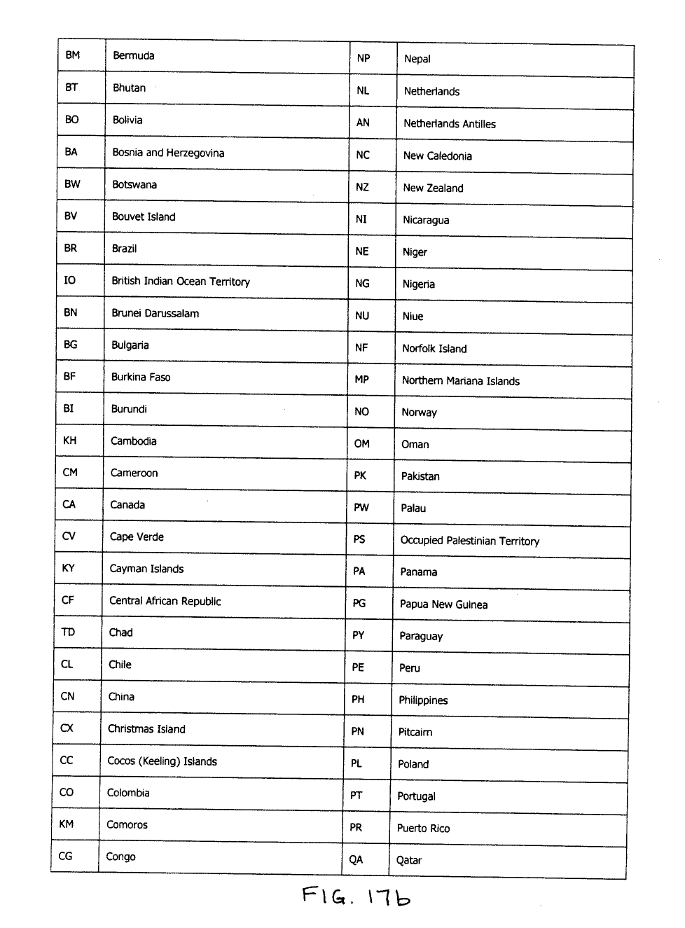

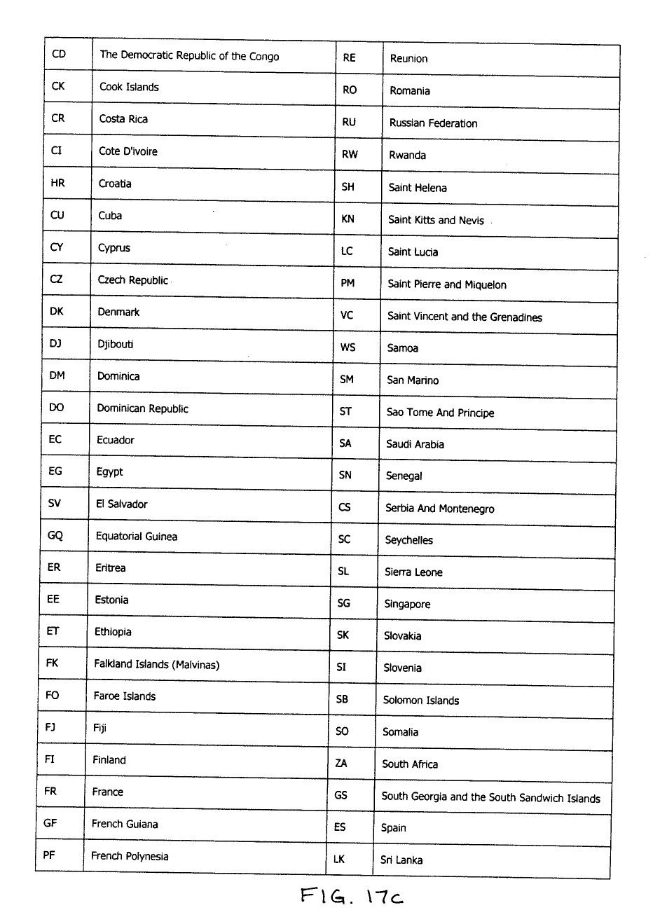

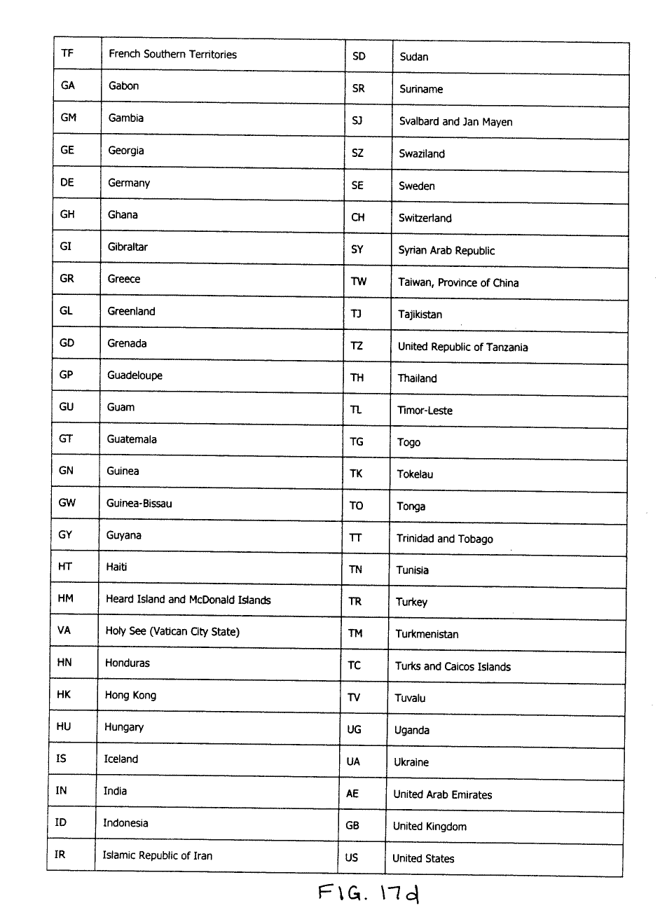

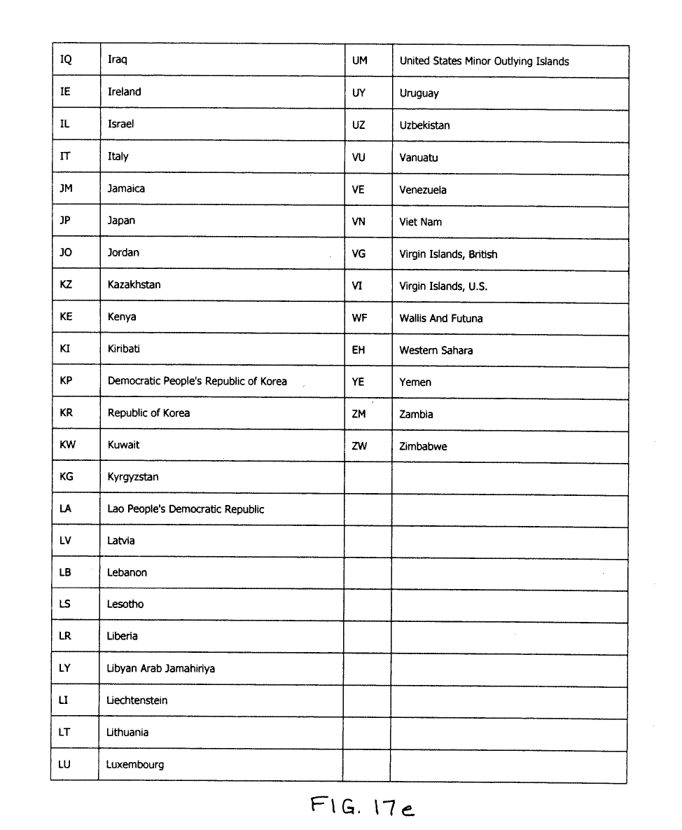

As discussed above, many embodiments of the present invention use a standardized vocabulary formed from a set of URI References. Each URI Reference in a vocabulary can be given an identifier, which is unique in the vocabulary. For example, the URI Reference “http://something.com/stuff/#thing” may have the identifier “0x0001.” The range of possible URI Reference identifiers is limited to all URI References in the standardized vocabulary. Each vocabulary has an identifier, which is unique to all vocabularies. The unique identifiers can reduce the amount of memory and processing power a decoder requires to navigate through a graph. Since the vocabulary URI References are predefined, a decoder can use the readily parseable identifiers instead of strings to identify the triples it wishes to decode. FIGS. 16a to 16h show a metadata vocabulary for multiple languages in accordance with an embodiment of the invention. FIGS. 17a to 17e show a metadata vocabulary for countries in accordance with an embodiment of the invention.

### Complex Metadata Relationships

FIG. 4 shows a conceptual diagram of a triple with cardinality in accordance with an embodiment of the invention. Cardinality generally refers to the number of elements in a set. In one embodiment, a triple may have more than one object related to a subject with the same predicate, i.e. the cardinality would be more than one. The triple 40 can have a first object 44 and a second object 46 related to a subject 41 by the same predicate 42.

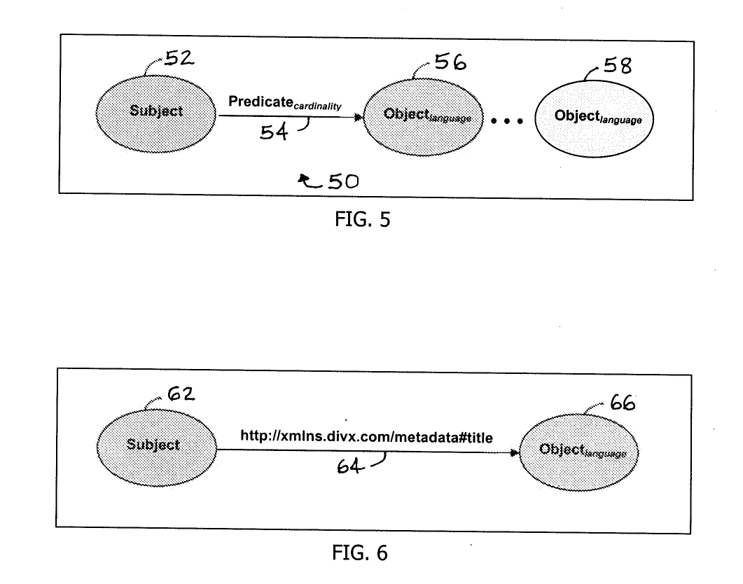

FIG. 5 shows a conceptual diagram of a triple localized in multiple languages in accordance with an embodiment of the invention. In many embodiments, objects in a triple can support more than one language. A triple 50 with a subject 52 and predicate 54 can have an object 56 and an object 58, the latter of which is not an object of the subject but an object of the object 56. Conceptually, the object 58 is not assigned to the subject, but is rather a feature of the object 56. In several embodiments, only values may be localized or initialized for multiple languages. Localized in this context means to confine an entity to a specific locality. In this case, we are identifying a language, and optional region, of a value. In other words, the value's data is viewable in the specified language.

FIG. 6 is a conceptual diagram of a triple with a URI Reference in accordance with an embodiment of the invention. In one embodiment, the triple 60 has a subject 62, a predicate 64 consisting of a URI Reference, and an object 66. The URI Reference can be “http://xmlns.divx.com/metadata#title.”

### Implementations of Metadata Data Structures

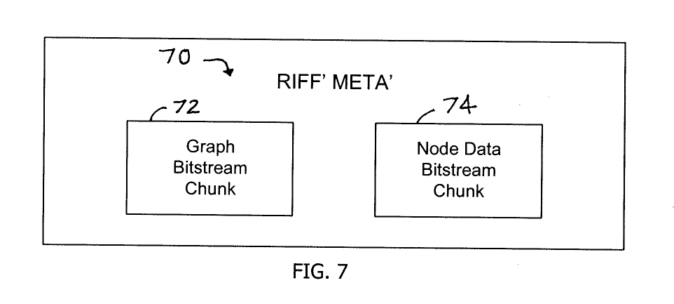

FIG. 7 is a diagram of the structure of a RIFF metadata chunk in accordance with an embodiment of the present invention. The RIFF metadata chunk 70 includes a graph bitstream chunk 72 and a node data bitstream chunk 74. These two bitstreams are inherently related. The graph bitstream chunk contains the detail of the triples of a particular graph. The node data bitstream chunk can contain the data for the URI References and values of the nodes in the triples. This separation between the nodes and the node data can minimize the amount of memory required for decoding metadata. The entire node data section need not be completely loaded into memory. Instead, the decoder need only load the data it needs.

### The Graph Bitstream

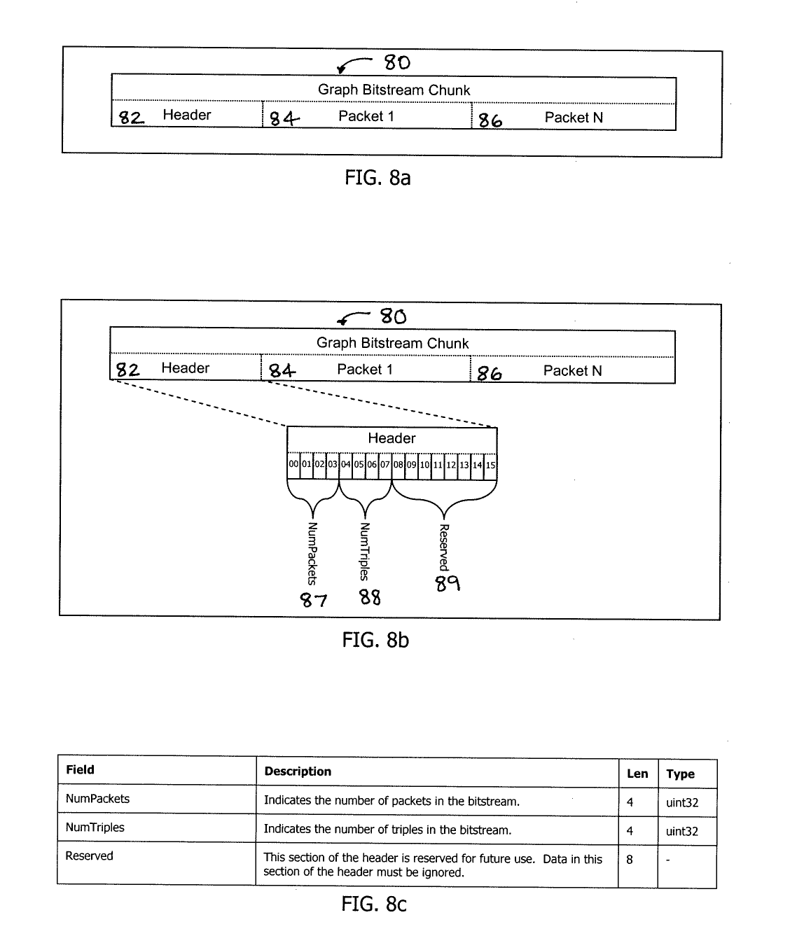

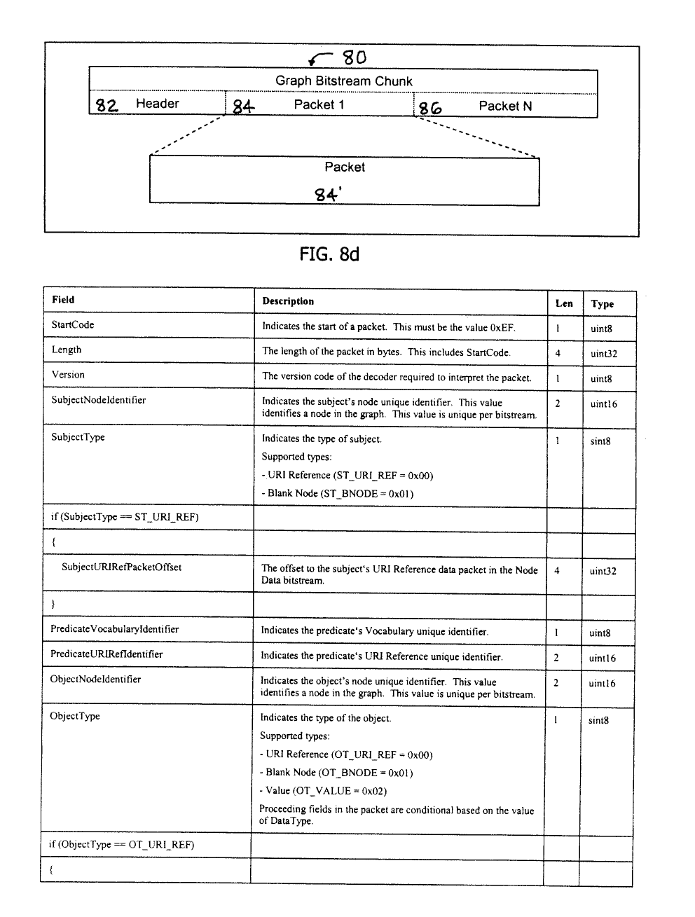

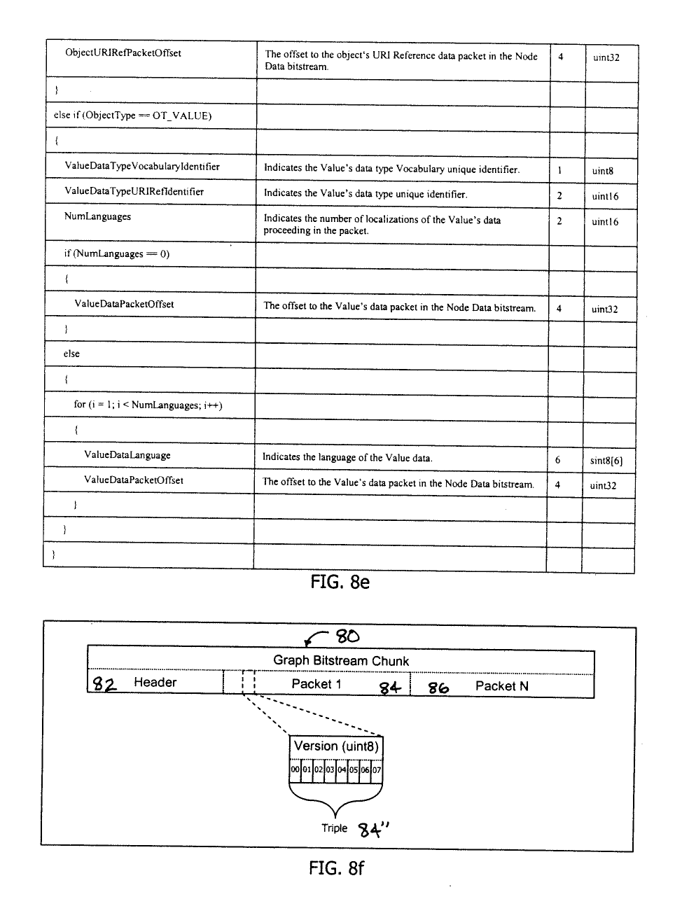

FIG. 8a shows a diagram of the structure of a graph bitstream chunk in accordance with an embodiment of the present invention. The graph bitstream chunk 80 includes a header 82 and a sequence of packets. The sequence can include a first packet 84, and a last packet 86. The graph bitstream chunk can have any number of packets.

The order of the packets in a sequence can also be arranged to minimize the amount of memory and processing power a decoder requires to store and navigate through a graph. For any packet in a sequence, with the exception of the first packet, the subject of the triple represented by that packet is typically the object of the triple represented by a previous packet. The previous packet may be immediately before the packet or a number of packets before. Embodiments that structure the bitstream so that packets only reference previous packets allow for sequential access of a bitstream. Sequential access can reduce the memory and processing power required to navigate through a graph. Sequential access can also allow a decoder of metadata to ignore triples it will not be requiring and to leave the ignored triples out of the constructed graph. The ability to ignore portions of the metadata can reduce the memory required to store the graph.

FIG. 8b shows a diagram of the structure of a graph bitstream chunk with a breakout of the header section in accordance with an embodiment of the present invention. The header 82 includes a NumPackets field 87, a NumTriples field 88, and a reserved field 89 for later use.

FIG. 8c shows a table describing components of the header section of the graph bitstream chunk in accordance with an embodiment of the present invention. According to the table, the “NumPackets” field can indicate the number of packets in the bitstream. The “NumPackets” field can be four bytes in length and of type “uint32.” The “NumTriples” field can indicate the number of triples in the bitstream. The “NumTriples” field can be four bytes in length and of type “uint32.” The “Reserved” field can be reserved for future use and the data contained therein ignored until then. The “Reserved” field can be eight bytes in length.

FIG. 8d shows a diagram of the structure of a graph bitstream chunk with a breakout of a packet section in accordance with an embodiment of the present invention. As discussed above, the graph bitstream chunk 80 includes a header 82 and a sequence of packets. The sequence can include a first packet 84 and a last packet 86. The graph bitstream chunk can have any number of packets. In many embodiments, a typical packet 84′ can include a number of fields that relate to the characteristics of the packet or provide references to other packets.

FIG. 8e shows a table describing components of a packet section of the graph bitstream chunk of FIG. 8d in accordance with an embodiment of the present invention.

### Ongoing Modification of Metadata Data Structures and Vocabulary

Content description systems in accordance with embodiments of the present invention can enable modification over time of the data structures used to represent the metadata triples and also to the vocabulary employed by the triples. Modifications to the metadata data structures and the vocabulary can by identified using version numbers.

The version number of the metadata data structure used to represent a metadata triple can be located in each graph bitstream chunk within a “version” field. FIG. 8f shows a diagram of the structure of a graph bitstream chunk with a breakout of the version portion of a packet section in accordance with an embodiment of the present invention. As discussed above, the graph bitstream chunk can include any number of packets. In many embodiments, the packets include a version field 84″. In the illustrated embodiment, the version field is eight bytes long and of the “uint8” type.

The version field 84″ can be used to contain a triple version number. The triple version number specifies the version of the decoder required to decode and interpret the packet. Packets with higher triple version numbers can describe the same triple (i.e. the same subject) as a packet of a lower version number. The higher version packet can amend or replace the description made in a lower version. In one embodiment, decoders ignore packets with triple versions above their capabilities.

As discussed above, different versions of the metadata vocabulary can be supported by embodiments of content description systems in accordance with the present invention. The vocabulary version number is typically provided each time a URI Reference is made. In one embodiment, the vocabulary can be used in specifying the triple predicate and the data type of a value. For a triple predicate, the vocabulary number can be located in each graph packet chunk under the “PredicateVocabularyIdentifier” and “ValueDataTypeVocabularyIdentifier” fields, as seen in FIG. 8e.

In several embodiments, anyone can add to the vocabulary of the content distribution system through a user group or standards body responsible for the maintenance and content of the vocabulary. In this way, the vocabulary is a dynamic, updatable entity that is increasing in size, while making the content description system more powerful, yet fully realizable by restricting authority to change or add to the vocabulary to one authority.

### The Node Data Bitstream

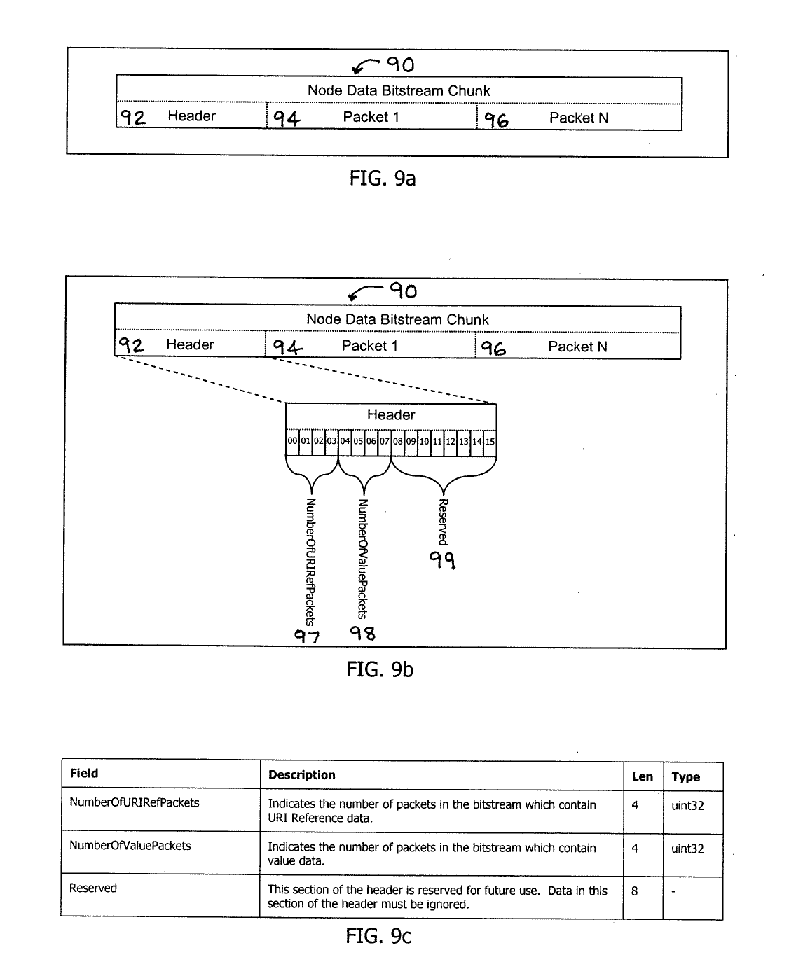

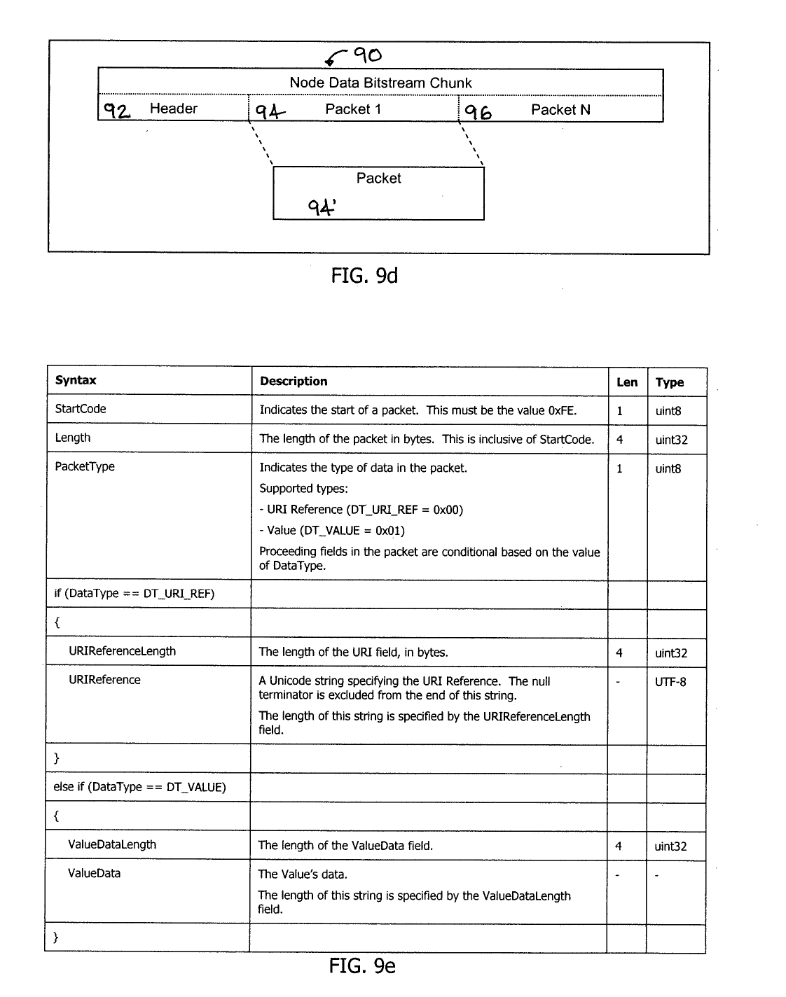

FIG. 9a shows a diagram of the structure of a node data bitstream chunk in accordance with an embodiment of the present invention. The node data bitstream chunk 90 includes a header 92 and a sequence of packets. The sequence can include a first packet 84, and a last packet 86. The node data bitstream chunk can have any number of packets.

FIG. 9b shows a diagram of the structure of a node data bitstream chunk with a breakout of the header section in accordance with an embodiment of the present invention. The header 92 includes a “NumOfURIRefPackets” field 97, a “NumOfValuePackets” field 98, and a “Reserved” field 99 for later use.

FIG. 9c shows a table describing components of a header section of a node data bitstream chunk in accordance with an embodiment of the present invention. According to the table, the “NumOfURIRefPackets” field can indicate the number of packets in the bitstream which contain URI Reference data. The “NumOfURIRefPackets” field can be four bytes in length and of type “uint32.” The “NumOfValuePackets” field can indicate the number of packets in the bitstream which contain value data. The “NumOfValuePackets” field can be four bytes in length and of type “uint32.” The “Reserved” field can be reserved for future use and the data contained therein ignored until then. The “Reserved” field can be eight bytes in length.

FIG. 9d shows a diagram of the structure of a node data bitstream chunk with a breakout of a packet section in accordance with an embodiment of the present invention. The node data bitstream chunk can have any number of packets. In many embodiments, a typical packet 94′ can include a number of fields that relate to the characteristics of the packet or provide references to other packets.

FIG. 9e shows a table describing components of a packet section of the node data bitstream chunk of FIG. 9d in accordance with an embodiment of the present invention.

### Representing Metadata Using Graph and Node Data Bitstreams

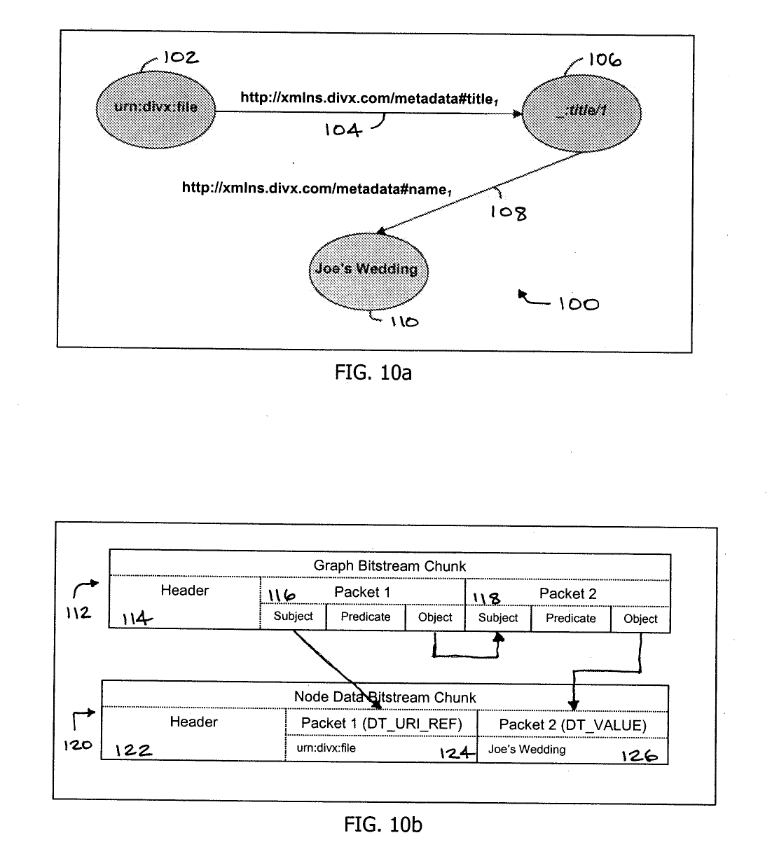

FIG. 10a shows a conceptual diagram of a graph of multiple triples in accordance with an embodiment of the invention. The graph 100 contains two triples represented by three nodes (102, 106, and 110) and two arcs (104, 108).

FIG. 10b shows a diagram of the structure of the graph and node data bitstream chunks of the triples of FIG. 10a in accordance with an embodiment of the invention. The graph bitstream chunk 112 can be a sequence of packets. Each packet can represent a triple. The bitstream can be considered the graph to which the triples belong.

As discussed earlier, a triple can contain a subject, predicate, and object. Each of these can have associated data. For the subject and predicate, the associated data can typically be a URI Reference. Due to the length and the varying nature of the data shown in FIG. 10a, it is stored in a separate bitstream, the node data bitstream chunk 120. For example, the first packet 124 of FIG. 10b contains the data of the subject node 102 of FIG. 10a. For example, the second packet 126 of FIG. 10b contains the data of the object node 110 of the second triple of FIG. 10a. To facilitate the location of the node information, the graph packets can contain offsets into the node data bitstream. Each offset can contain a reference to a node data packet, which contains the data for each subject, predicate, and object. For example, the subject portion of the first packet 116 in the graph bitstream chunk references the first packet 124 of the node data bitstream chunk, and the value of the subject, “um:divx:file,” is stored there. This method of separating the node data from the graph can minimize the amount of memory required to manipulate metadata.

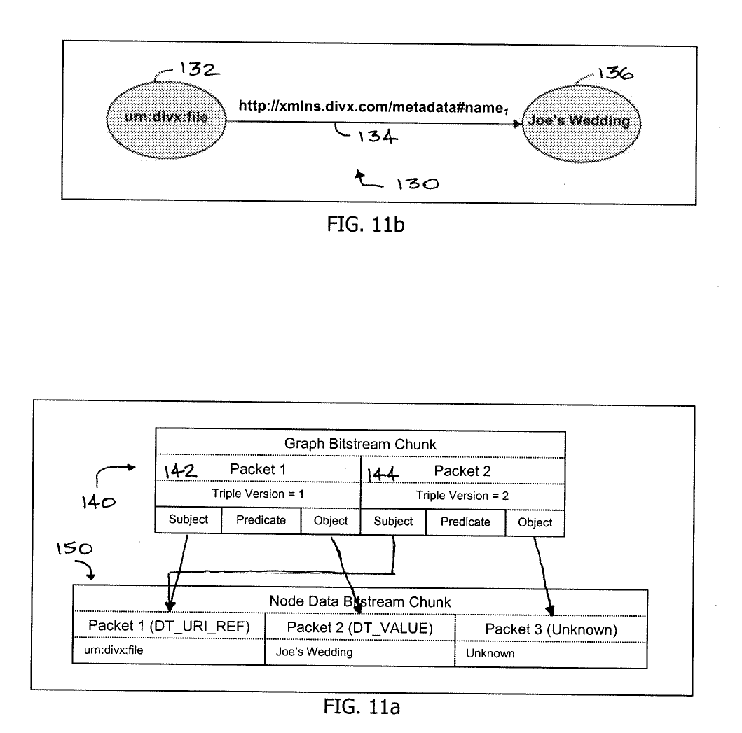

FIG. 11a shows a diagram of the structure of graph and node data bitstream chunks with multiple triple versions in accordance with an embodiment of the invention. The graph bitstream chunk includes a first packet 142 and a second packet 144. The first packet 142 possesses a triple version of one, while the second packet 144 possesses a triple version of two. In one embodiment, a metadata version one decoder ignores the second packet 144, since it generally ignores triple versions higher in number, and produces the graph of FIG. 11b.

FIG. 11b shows a conceptual diagram of a graph in accordance with the graph and node data bitstream chunks of FIG. 11a. The graph 130 includes a subject node 132 containing the node data (“um:divx:file”) a predicate 134, and an object 136 containing the referenced node data (“Joe's Wedding”). In embodiments where a decoder does not possess the ability to decode metadata expressed in a particular version of a metadata format (such as the second packet shown in FIG. 11a, the decoder can ignore the metadata packet.

As discussed above, different version systems can be specified for the metadata format (i.e., the format in which the metadata is represented) and for the standardized vocabulary (e.g., the set of valid URIs defined as the vocabulary) employed in describing the metadata.

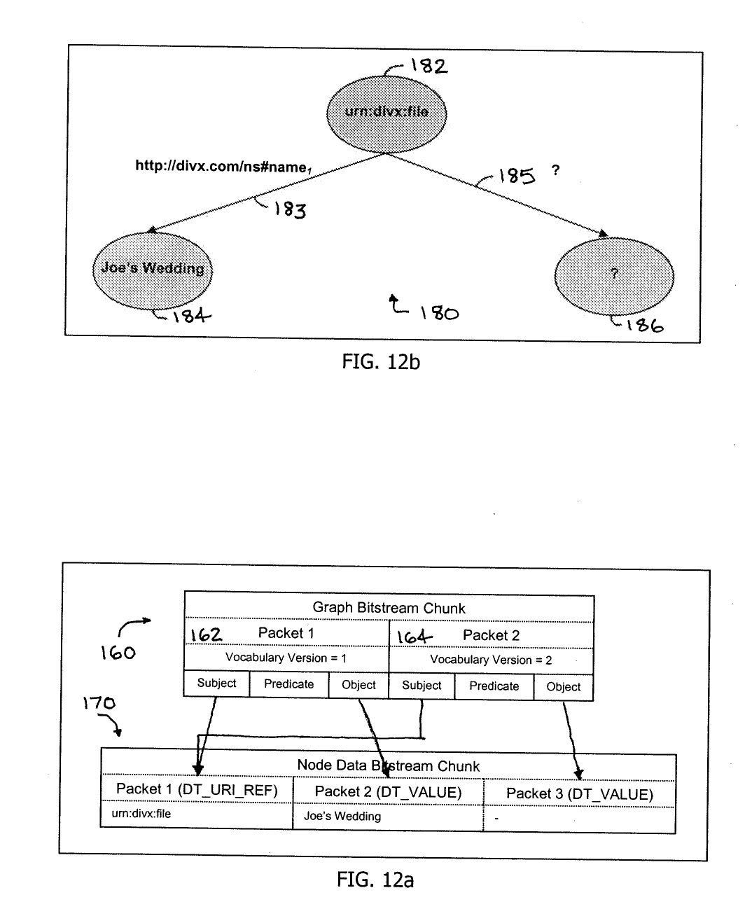

FIG. 12a shows a diagram of the structure of graph and node data bitstreams chunks in accordance with an embodiment of the invention. The graph bitstream chunk includes a first packet 162 and a second packet 164. The first packet 162 has a vocabulary version of one, while the second packet 164 has a vocabulary version of two. In one embodiment, a metadata version one decoder still includes the triple from the second packet 144, and produces the graph of FIG. 12b.

FIG. 12b shows a conceptual diagram of a graph in accordance with the graph and node data bitstream chunks of FIG. 12a. In one embodiment, a metadata decoder produces a graph 180 including the triple from the first packet 162 of FIG. 12a, and the triple from the second packet 164 of FIG. 12a, even though the latter triple is unknown. The known triple includes a subject node 182 containing the referenced node data, “um:divx:file,” the predicate 183, “http://divx.com/ns#name₁,” and the object 184 containing the referenced node data, “Joe's Wedding.” The unknown triple can include a subject node 182, predicate 185, and object node 186.

### Metadata Decoders

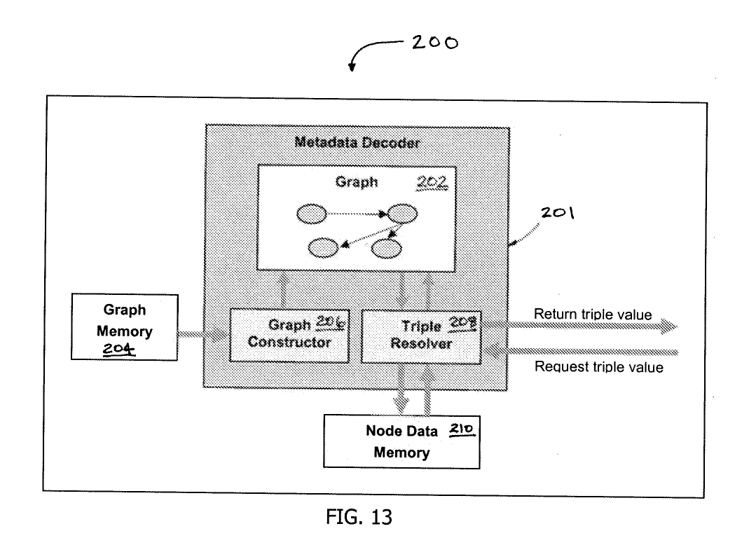

FIG. 13 shows a block diagram of a metadata decoder system in accordance with an embodiment of the invention. The metadata decoder system 200 includes a metadata decoder 201, a graph memory 204, and a node data memory 210. The metadata decoder 201 can also include a graph 202, a graph constructor 206, and a triple resolver 208.

In operation, the graph of triples 202 can be loaded upon initialization of the decoder 201. In many embodiments, the graph need only be loaded once. In many embodiments, only the portions of the node data bitstream chunk that are requested by the decoder 201 need be loaded. The entire node data bitstream chunk need not be loaded. In many embodiments, only the portions of the graph bitstream chunk that are requested by the decoder 201 need be loaded. The entire graph bitstream chunk need not be loaded.

### Operation of a Metadata Decoder

Once a graph has been constructed, a metadata decoder in accordance with an embodiment of the present invention can use the metadata in any of a variety of ways. In many embodiments, a user can instruct a decoder 201 to locate a particular piece of metadata. In response, the decoder can search to see whether the requested metadata can be found within the graph 202. If the requested metadata is contained within the graph, then the decoder locates the metadata by a search of the node data memory 210. If the requested metadata was not found within the graph 202, then the decoder 201 returns a value indicating that the metadata was not found.

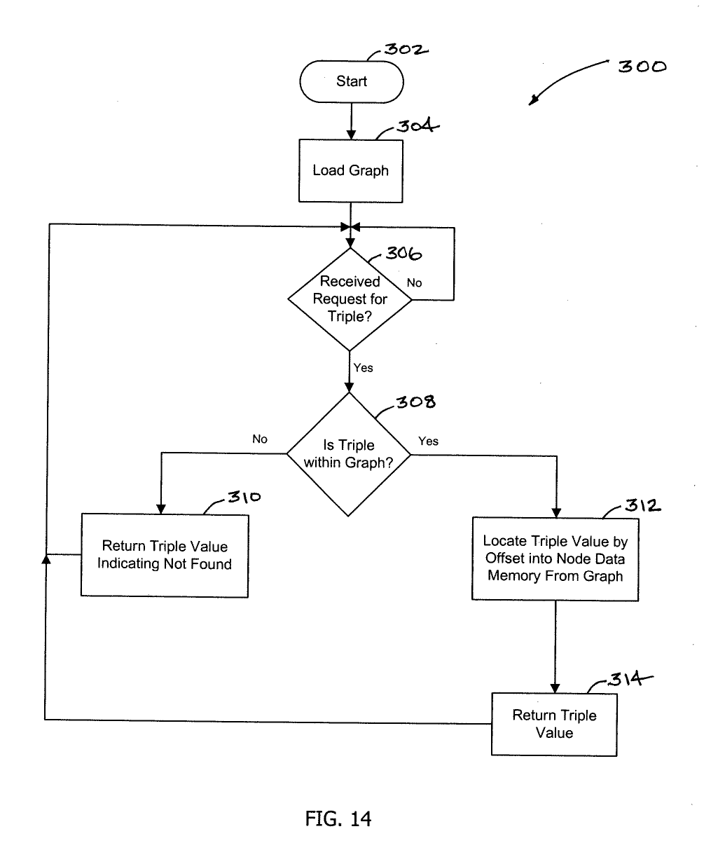

FIG. 14 shows a flowchart of the operation of the metadata decoder system of FIG. 13 in accordance with an embodiment of the invention. In the process 300, after the start (302), the decoder can load (304) a graph. The decoder can then check (306) to see if a request for metadata has been made. If a request has not been received, the decoder can keep checking.

If a request for metadata has been made, then an attempt is made to locate (308) the requested metadata within the graph. If the metadata can be located, then the decoder can use an offset specified in the graph to locate (312) the metadata value within the node data memory. After locating the metadata, the decoder can return (314) the metadata value. If the requested metadata is not within the graph, then the decoder can return (310) a value indicating that the metadata was not found. The decoder can then continue to check (306) for requests for metadata.

A metadata search, similar to the search described above, can be facilitated by use of a specified vocabulary to ensure a standard set of terminology is used both for the search and for the expression of the metadata. However, in many embodiments, the vocabulary is modified from time to time. As discussed above, expansion of the vocabulary can be accommodated by incorporating version identifiers in the metadata.

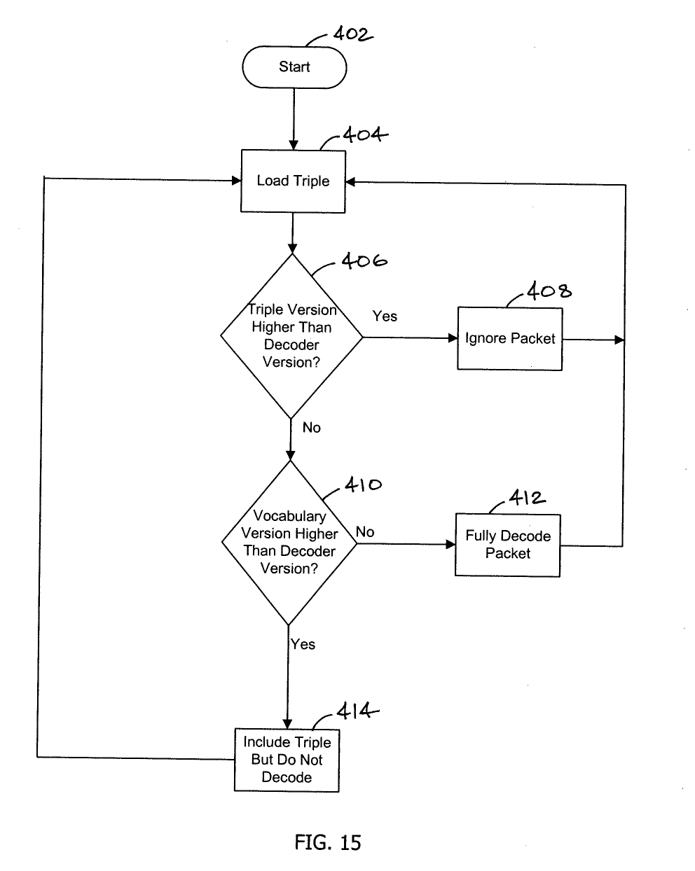

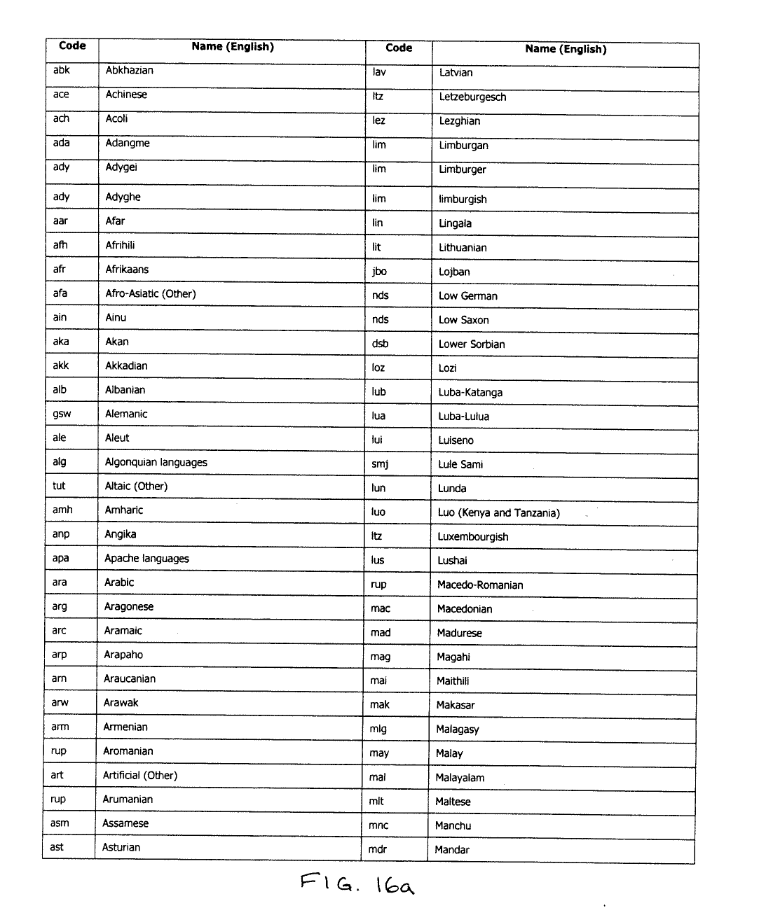

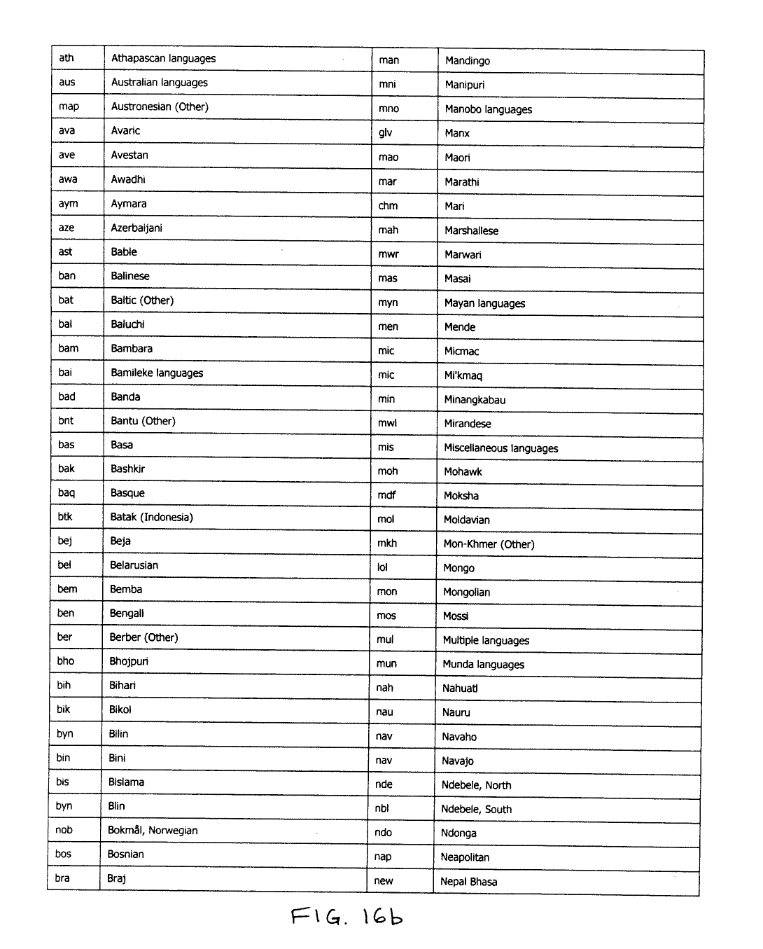

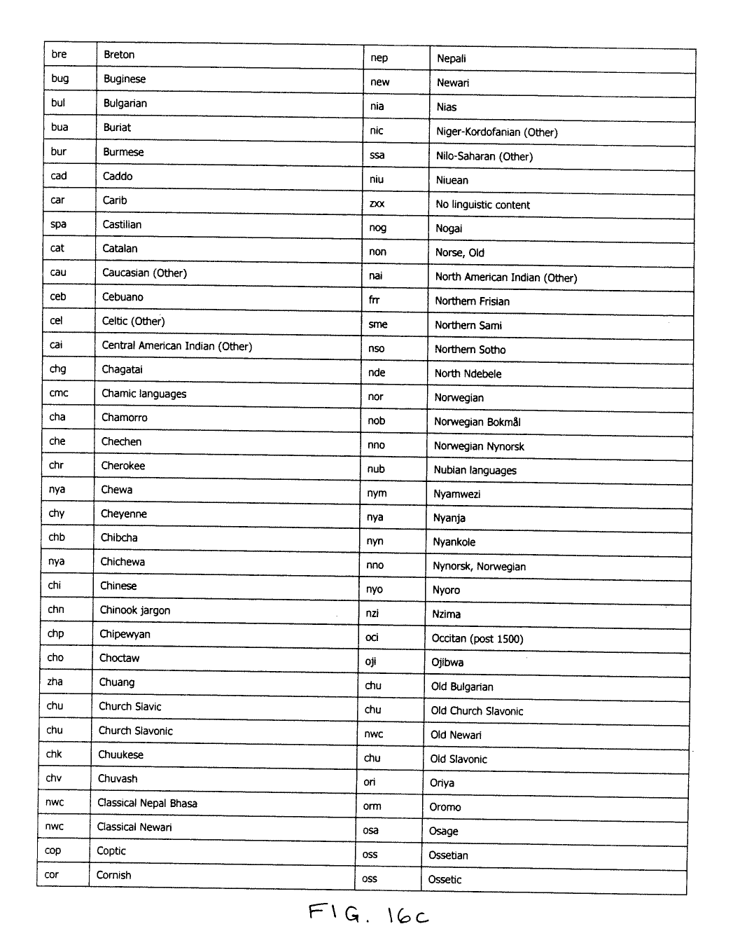

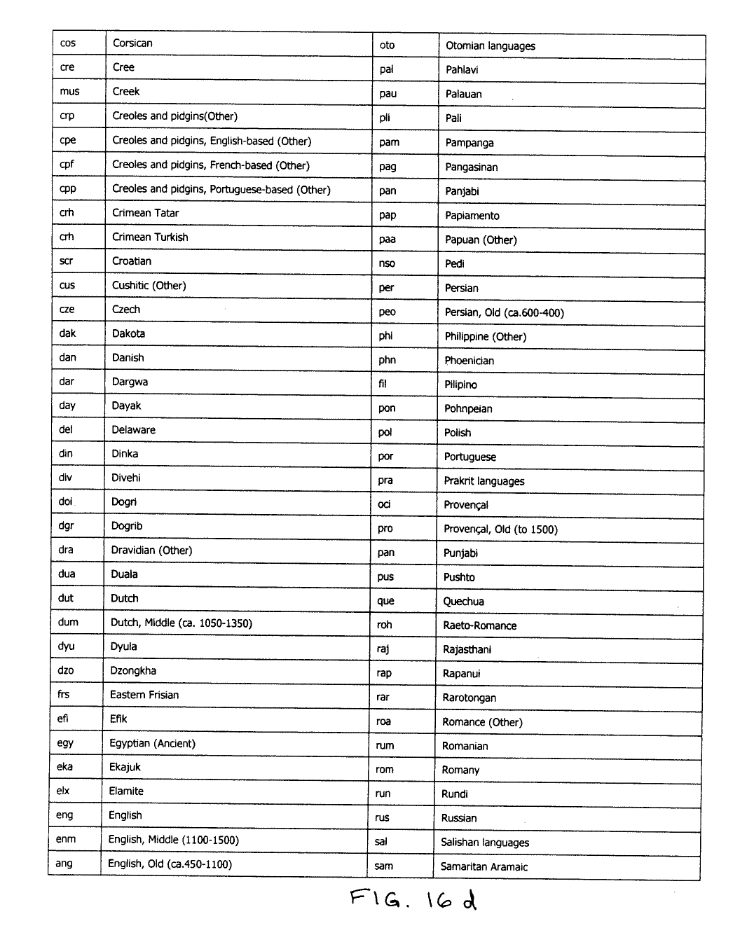

FIG. 15 shows a flowchart of the operation of the metadata decoder system of FIG. 13 with regard to versioning in accordance with an embodiment of the invention. In the process 400, after the start (402), the decoder can load (404) a triple. The decoder can then check (406) to see if the triple version is higher than the decoder version. If the answer is “yes,” the decoder ignores (408) the packet and loads (404) another triple. If the answer is “no,” the decoder checks (410) to see if the vocabulary version of the triple is higher than that of the decoder.

If the vocabulary version of the triple is not higher than that of the decoder, then the decoder fully decodes (412) the packet and loads (404) another triple. If the vocabulary version of the triple is higher than that of the decoder, then the decoder includes the triple without decoding (414) it and loads (404) another triple.

The above discussion provides examples of how a metadata decoder in accordance with embodiments of the present invention can locate metadata by performing a simple search. Metadata decoders in accordance with embodiments of the present invention can also perform other high level operations such as entailment and recommendation.

Entailment is a relationship between propositions whereby the truth of a first proposition guarantees the truth of a second proposition. Under entailment, it is impossible for the first proposition to be true and the second proposition to be false. In addition, entailment implies that all expressions of the second proposition may be deduced from the first proposition. For example, the first proposition could be “coffee boosts energy and provides health benefits.” The second proposition could be that “coffee gives health benefits.” So, the truth of the first proposition guarantees the truth of the second proposition. It is not possible that the proposition “coffee boosts energy and provides health benefits” is true and the proposition “coffee gives health benefits” is false. Entailment can also be thought of as a relationship between sentences, in the form of propositions, that is based on semantics.

The process of using a formal vocabulary and entailment to make useful deductions is called recommendation. For example, suppose that Tom's music and movie tastes are stored in metadata by a metadata device and indicate that Tom prefers many of the same movies as Mary. In one embodiment of a content description system, a metadata device can be enabled with a first proposition like “metadata users who like the same movies will like the same music.” Tom's movie preferences stored in metadata might indicate a preference for action movies along with a preference for The Beatles. Mary's movie preferences stored in metadata can also indicate a preference for action movies. A second proposition, determinable by a metadata device using entailment, can be that Tom and Mary like the same music. Entailment can suggest that because the first proposition is true, the second proposition must also be true. Thus, Tom and Mary will like the same music. Entailment combined with the metadata vocabulary can allow a machine to make the inference that Mary would also have an affinity for Tom's music preferences. Metadata and entailment can then enable a metadata device to use this information to recommend to Mary The Beatles.

In several embodiments, the metadata is carried with the other content within a file. Thus, information concerning the content of a file is available on demand. This information contained in the metadata can be virtually unlimited, as metadata can link and be updated by other metadata. For example, in one embodiment, a multimedia file could contain a movie and information concerning an actor that appears in the movie stored as metadata. The movie and associated metadata typically would not be separated. Thus, a user wanting to know specific information about the actors in a particular movie would have that information available. That information could include the other movies in which a particular actor also performed. Thus, a user of a consumer electronics device in accordance with an embodiment of the present invention can use the metadata to find movies in which that actor has appeared. The ability of users to create metadata can also enable the user to inspect other users' reviews of the movies in which the actor appears.

### Contextual Advertising

Many of the high level operations described above can be used to create software applications. One example of a software application in accordance with an embodiment of the present invention is software that provides marketing materials specifically tailored to a user based on information provided by or collected concerning the user. If video, photo, and/or audio content provided to users is described by a content description system in accordance with an embodiment of the present invention, then the preferences of the users can be observed. Inferencing and recommendations can be used to select advertising that may be particularly relevant to a user. Take as an example a user that views a home movie of a relative's new born baby. The home movie can in accordance with an embodiment of the present invention include metadata that describes the following:
the subject of the video is a person; and
the person is a new born baby.

Software in accordance with an embodiment of the present invention could use the above metadata and metadata concerning the user to detect that a relationship exists between the subject of the video and the user. The software could also use entailment to determine that the user is likely to want to view a commercial showing baby gifts, because an advertiser has generated metadata stating that the commercial is relevant to relatives of new born babies.

### Updating Metadata

In many embodiments, metadata can be updated. A metadata device can query a server containing metadata content to determine if the current metadata is the most recent version. If the current metadata is not the most recent version, the latest version can be downloaded from the server.

In one embodiment, a metadata distributor may offer official versions of metadata. For example, a particular movie studio might offer the official version of a movie produced by the studio. The official version might contain rich metadata content. In this context, rich metadata content can refer to metadata which not only provides a method for presenting, managing, and finding information, but provides the data for analytical functions. For example, rich metadata content can include the names of all the actors, directors, their associated biographical information, and information on other movies each actor or director participated in. This official version could be offered for download by a server. The unofficial or other versions of the same movie might include only the video content and not the additional associated information such as the background of the participating actors and directors. For example, the unofficial versions could be distributed by a television network, while the official versions could be distributed by the producer of the work. In this example, the unofficial work could likely be free while the official work might require a fee for the value added content.

As described above, rich metadata can contain a greater content than other metadata. Rich metadata can also provide for greater functionality. In one embodiment, greater functionality could include, for a purchaser of a product using rich metadata, the ability to download additional content from a server. The rich functionality can include the ability to search the server and download all the works of a particular actor, including television shows, movies, plays, etcetera. Effectively, the rich metadata user can add to the user's collection of metadata. The greater functionality can generally refer to making use of the vast and exhaustive content. Other versions of metadata can lack this extensive content and thus also lack the greater functionality.

### Contextual Recommendation and Discovery

Many of the high level operations described above can be used to create software applications. One example of a software application in accordance with an embodiment of the present invention is software that provides recommendations of people, content, and content creators specifically tailored to a user based on information provided by or collected concerning the user. If video, photo, and/or audio content provided to users are described by a content description system in accordance with an embodiment of the present invention, then the preferences of the users can be observed and recorded. Inferencing and recommendations can be used to selectively discover people, content, and content creators that may be relevant to a particular user. Inferencing and recommendations may be performed on a collection of the user's recorded content selections, which can be logged based on the metadata associated with each piece of content a user has watched.

For example, suppose a user has watched three pieces of content in which a particular actor has appeared in a starring role. By using inferencing and the metadata associated with each piece of content, the particular actor can be identified as an actor common to all the content. With this knowledge, recommendations to the user can be made based on an association between content and the identified actor. The inferencing process may also incorporate metadata associated with people, content, and content creators from an online service. The inferencing process can be performed locally on the user's client, which may be a computer, mobile phone, or other device. The user's client can also be a server, which may be wired or wirelessly connected using any of a variety of networking protocols.

Results of the inferencing process can be presented to the user, which enables the user to discover people, content, or content creators previously unknown to the user or unassociated with the user. The inferencing process can also be used during the real-time playback of content by a user. For example, consider a user watching a sporting event. Depending on who or what is in a scene and what is occurring in a scene, the recommendation and discovery process outlined above be used. People, content, and content creators that are related to the scene can be presented to the user as they watch the sporting event. For example, a user watching a live broadcast of a professional football game involving a favorite football team might have an interest in other sporting events or related goods associated with the team. Using the inferencing process and metadata, recommendations of sporting events in the viewer's area or sporting goods relating to the viewer's favorite team can be made to the user, possibly in the form of advertising during the sports broadcast.

### Metadata Authorities

Individual pieces of metadata may have an associated authority. In this context an authority can be an individual, group, or organization that is responsible for the information contained in a particular piece of metadata. An individual piece of metadata may possess different authorities. That is, a piece of metadata tagged with the same vocabulary, may be available from multiple authorities. While using metadata to search and find information along with the higher level functions of recommendation and discovery, the authority of a piece of metadata may be taken into consideration. For example, consider a film which has two pieces of metadata for the film's rating. The authority for the first rating being from a popular online movie database with ratings derived from community driven voting. The authority for the second rating being from a popular film critic from a major newspaper. Depending on the intended consumer/user of the metadata, processing a result from the first rating may be preferred over processing a result from the second rating, or vice versa, or both ratings may be averaged, or both ratings may be ignored, or another calculation may be used.

Variations, modifications, and other implementations of what is described herein will occur to those of ordinary skill in the art without departing from the spirit and the scope of the invention as claimed. Although the invention has been described with respect to certain embodiments, it should be recognized that the invention includes the claims and their equivalents supported by this disclosure.

What is claimed is:

1. A storage device, comprising:
a storage medium; and
metadata recorded in the storage medium;
wherein the metadata includes graph information and separate node data.

2. The storage device of claim 1, wherein:
the graph information includes a sequence of packets containing metadata triples; and
the metadata triples include data representing a subject, a predicate and an object.

3. The storage device of claim 2, wherein each metadata triple includes data representing a version.

4. The storage device of claim 2, wherein a version is associated with each piece of data representing a subject, a predicate or an object.

5. The storage device of claim 2, wherein:
the node data includes a sequence of packets; and
each packet contains reference data or a data value.

6. The storage device of claim 5, wherein:
the subject in a metadata triple includes a reference to a packet containing node data; and
the referenced packet contains reference data.

7. The storage device of claim 5, wherein:
the predicate in a metadata triple includes a reference to a standard vocabulary.

8. The storage device of claim 5, wherein:
the object in a metadata triple includes a reference to a packet containing node data; and
the referenced packet contains a data value.

9. The storage device of claim 5, wherein:
the object in a metadata triple includes a reference to a packet containing node data; and
the referenced packet contains reference data.

10. The storage device of claim 5, wherein the subject or the object in a metadata triple includes a reference to a blank node.

11. The storage device of claim 1, wherein the data is a file including a metadata chunk.

12. The storage device of claim 11, wherein the file includes multimedia stored in a RIFF chunk.

13. A storage device, comprising:
a storage device containing a file;
wherein the file includes multimedia stored in a RIFF chunk and a metadata chunk.

14. The storage device of claim 13, wherein the metadata chunk includes a chunk containing graph information and a chunk containing node data.

15. A metadata decoding system, comprising:
a processing device;
a storage device;
a graph memory; and
a node data memory;
wherein metadata is stored on the storage device;
wherein the metadata includes graph information and node data;
wherein the processor is configured to load the graph information into the graph memory; and
wherein the processor is configured to construct a graph using the graph information.

16. The metadata decoding system of claim 15, wherein:
the graph information includes metadata triples that include data representing a subject, a predicate and an object; and
the subject, the predicate and the object each reference node data.

17. The metadata decoding system of claim 16, wherein:
the metadata decoding system is assigned a version;
the metadata triple is assigned a version; and
the processor is configured to only store metadata triples in the graph memory that have a version that is the same as or earlier than the version of the metadata decoding system.

18. The metadata decoding system of claim 16, wherein the metadata triple uses a standardized vocabulary.

19. A recommendation system, comprising:
a computing device; and
at least one storage device containing a plurality of sets of metadata;
wherein at least one of the storage devices includes at least one inference rule;
wherein each set of metadata includes graph information and separate node data; and
wherein the computing device is configured to generate a recommendation using the inference rules to search the sets of metadata.

20. The content description system of claim 19, wherein the processor is configured to construct graphs using the sets of metadata in the and to search the graphs using the at least one inference rule to make recommendations

21. A contextual advertising system, comprising:
a computing device; and
at least one storage device containing metadata;
wherein the metadata includes graph information and node data;
wherein at least one of the storage devices includes at least one advertising rule; and
wherein the computing device is configured to select advertising based on a search of the metadata using the advertising rules.

22. The contextual advertising system of claim 21, wherein the processor is configured to construct a graph using the metadata and to search the graph using the at least one advertising rule to identify an appropriate advertisement.

23. A method of description, comprising:
expressing descriptive information in triples including a subject, a predicate and an object; and
representing the triples as a graph and a series of nodes referenced by the graph.

24. The method of claim 23, further comprising recording the graph and the nodes in a file as separate chunks within a metadata chunk.

25. The method of claim 24, further comprising forming a graph chunk as a sequence of packets where each packet includes a subject, a predicate and an object.

26. The method of claim 25, further comprising forming the sequence of packets so that a node referenced by a subject in a packet in the sequence is not referenced by the object in a subsequent packet in the sequence.

27. The method of claim 23, further comprising:
expressing the descriptive information as triples that include a version; and
updating the triples using triples having a more recent version.

28 The method of claim 23, further comprising:
locating additional descriptive information expressed as triples associated with an authority; and
determining whether to update the expressed descriptive information with the additional descriptive information based upon the authority.

29. The method of claim 23, further comprising determining the preferred triple in a set of triples with the same subject, predicate, and object.
